(19) United States
(12) Patent Application Publication
(10) Pub. No.: US 2008/0115980 A1
(43) Pub. Date: May 22, 2008

(54) Hook for Scales

(76) Inventor: Syed Rizvi, Bakersfield, CA (US)

Correspondence Address: FURR LAW FIRM, 2622 DEBOLT ROAD, UTICA, OH, 43080, US

(21) Appl. No.: 11/306,533

(22) Filed: Dec. 31, 2005

(51) Int. Cl. G01G 19/52

(52) U.S. Cl. 177/264

(57) ABSTRACT

The present invention relates to professional scales. A hook for professional scales is provided. Hook allows the user of professional scale to hold the personal items while using the scale.

### PRIORITY CLAIM

This application claims priority from Disclosure Document No. 581787, filed Jul. 14, 2005, titled “Hook for Scales” and hereto attached.

### FIELD OF THE INVENTION

This invention relates to professional scales used to measure the weight and/or height of an individual. The said invention allows an individual to hold personal items while using the scale.

### STATEMENT OF THE INVENTION

Electronic or mechanical scales are routinely used to weigh individuals in healthcare setting. Some scales also have a height rod assembly to measure the height of individuals. Typically scales do not have an attachment or hook built in to allow individuals to hold the personal items like handbag while being weighed and measured. The present invention allows an individual to place and keep the personal items like handbag close by while using the scale. The invention eliminates the need to leave the bags and other personal items on the floor or finding a place to leave them while using the scale. This invention eliminates the likelihood of personal items being stolen, misplaced, mixed up with others or be contaminated on floor. This invention also eliminates the need for bending to place or pick up personal items off the floor while using the scale, which is particularly helpful for individuals with disabilities and medical conditions restricting range of motion.

Hook can be fixed, permanent and built in during design and manufacturing of the scale or be an aftermarket removable hook placed later. The permanent hook can be located anywhere on the scale. Optimal location for removable hook is the support bracket for height measurement assembly or under the head assembly on the side of column top. Favorable location to place the hook on scales without appropriate head assembly, for example electronic scales, is the support bracket for height measurement assembly. A screw can be used to fix the removable hook in place and prevent slippage or undesired movement.

### BACKGROUND OF THE INVENTION

Scales are commonly used in healthcare setting to weigh an individual and/or measure the height of an individual. Scales are standard equipment in establishments like hospitals, doctor's offices and fitness centers. Most people especially women cary handbag or other personal items, which need to be placed somewhere before weight can be taken. An individual cannot be weighed with the bag in hand as this will not give the accurate weight of the individual. The individual typically has to look for and find a place to leave the personal items, which is inconvenient and unsafe as the unattended personal items can be lost or misplaced. The lost or misplaced personal items can be a liability for the establishment as well as great loss to the individual.

When an adequate place is not available to leave the personal items close to the scale, individual has no choice but to leave the handbag on floor while using the scale. Some people are hesitant about leaving the handbag on floor and find it unhygienic.

The standard scales do not provide for mechanism to address this common and annoying problem.

It is, therefore, an object of the present invention to provide utility and method for overcoming the problems and limitations of the prior art.

Typically the individual using the scale has to walk to a place suitable to leave the personal items than walk back to the scale and after the measurement walk to get the items. If the item is left on the floor, the individual has to bend to pick it up. This is particularly difficult for people with disabilities and medical conditions restricting range of motion.

It is accordingly an object of the invention to provide a utility to reduce discomfort for people with disability and medical conditions while using the scale.

In accordance with this invention a hook is provided for scales. The individual using the scale can hold their personal items on the hook. The hook can be permanent or removable. Permanent hook can be any configuration and located anywhere on the scale as the manufacturer finds aesthetically, functionally or otherwise suitable.

Removable hook comprises of a solid round steel rod bent in several places to form a hook. Beside steel any other suitable material (plastic etc.) can be used to make the hook. A screw is used to fix the removable hook in place and prevent slippage or undesired movement. Any fixing mechanism other than screw can also be used to prevent undesirable movement of the hook.

### DESCRIPTION OF THE PREFERRED EMBODIMENT

Drawing description:

The drawings show the preferred configuration of the removable hook. The permanent hook can be any configuration as deemed appropriate during the design of the scale.

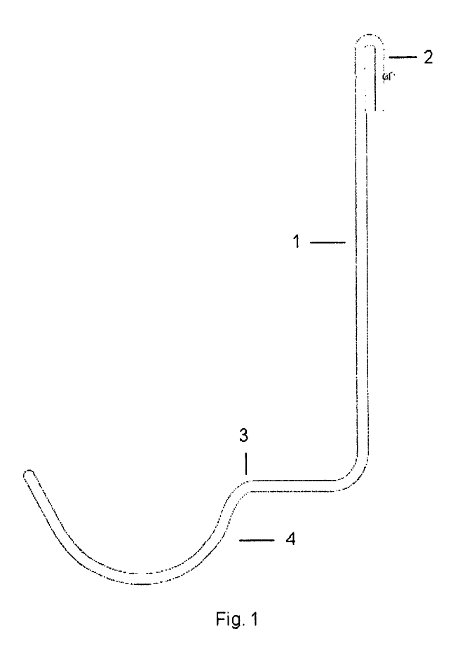

FIG. 1 shows the side view, body comprises of approximately ¼ inch radius rod. Shaft 1 is 6 inches long with a bend 2 on the top portion forming attachment location. This bent part 2 is about 1 inch long. Inner surfaces of the bent part and the shaft are approximately 1/10 inch apart and are flat to prevent undesired movement. Lower portion 3 is approximately 4.5 inches wide and has three bends forming a hook. The largest curved part 4 is approximately 1.5 inch high.

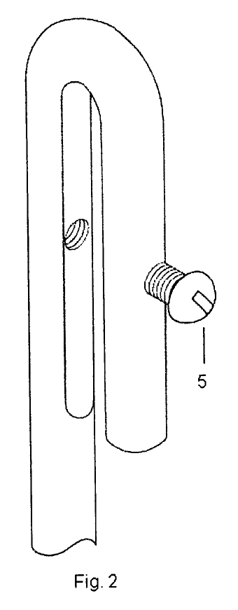

FIG. 2 shows the bent portion of the hook, which contains a hole with thread from each side to tighten and fix the hook using a screw 5. The hole with thread on both sides allows the ability to use the screw on either side as deemed appropriate by the installer.

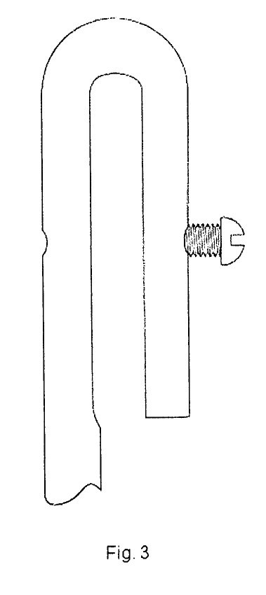

FIG. 3 shows the side view of the bent top portion.

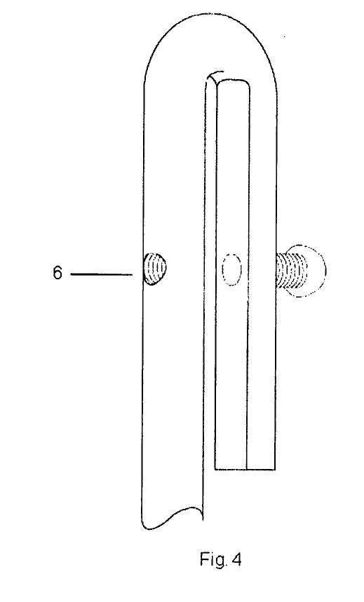

FIG. 4 shows the bent portion of the hook with threaded hole 6 of the other side.

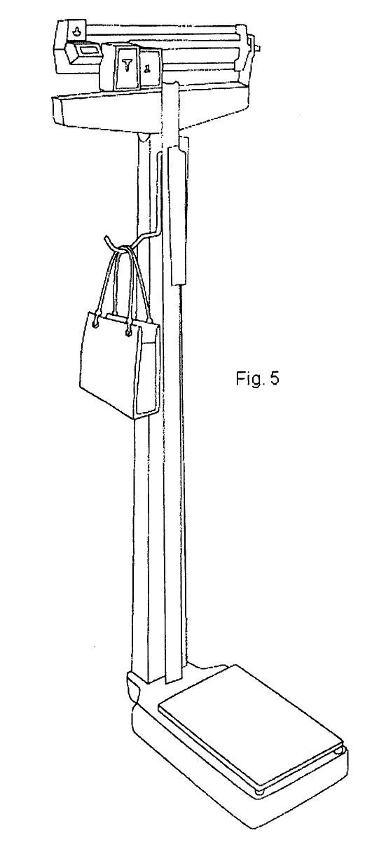

FIG. 5 shows the use of the hook on a mechanical professional scale, mounted on support bracket for height measurement assembly.

### OPERATION OF THE INVENTION

Removable hook is preferably placed under the head assembly on the side of column top or the support bracket for height measurement assembly. The individual using the scale places the personal item like handbag on the hook before using the scale. After the measurements are taken, the individual simply picks the item off the hook and walks away.

It is to be understood that both the general description and the detailed description are exemplary and explanatory but are not restrictive of the invention.

The invention in its broader aspects is not limited to the specific details shown and described, and departures may be made from such details without departing from the principles of the invention and without sacrificing its chief advantages. The dimensions are approximate and can be changed.

What is claimed is:

1. A hook for scales comprising;
an elongated shaft with one bend on the top forming attachment portion and three bends on the lower part forming a hook.

2. A utility as in claim 1 hold the personal items while using the scale.

3. A utility as in claim 1 to provide convenience to individuals using the scale.

4. A utility as in claim 1 to assist individuals with disabilities or medical condition while using the scale.

5. A utility as in claim 1 to avoid placing personal items on the floor while using the scale.

6. A utility as in claim 1, which is removable.

7. A utility as in claim 1 to allow an individual to keep personal items close by while using the scale without interfering with the measurement.

8. A tip of utility as in claim 1 with threaded holes on both sides allowing fixing and tightening the said utility from either side using a screw.

9. A permanent hook for scales comprising;
a hook for scales to hold personal items of individuals using the scale.
